(19) United States
(12) Patent Application Publication
(10) Pub. No.: US 2016/0110698 A1
(43) Pub. Date: Apr. 21, 2016

(54) METHOD AND SYSTEM FOR AUTOMATED PARKING VALIDATION

(71) Applicant: MasterCard International Incorporated, Purchase, NY (US)

(72) Inventor: Justin X. HOWE, San Francisco, CA (US)

(21) Appl. No.: 14/514,924

(22) Filed: Oct. 15, 2014

(51) Int. Cl. G06Q 20/14; G06Q 10/00; G06Q 30/02; G06Q 20/40

(52) U.S. Cl. CPC G06Q 20/145; G06Q 20/40; G06Q 10/00; G06Q 30/0207

(57) ABSTRACT

A method for automated parking validation includes: storing, in a memory of a computing device, a parking fee amount; receiving, by a receiving device, payment details associated with a transaction account; identifying, by a processing device, transaction data for an eligible payment transaction, wherein the transaction data includes at least a transaction time and/or date and a merchant identifier; discounting, by the processing device, the parking fee amount by a discount amount if the transaction time and/or date is within a predetermined period of time and the merchant identifier is one of a plurality of predefined merchant identifiers; and transmitting, by a transmitting device, an authorization request for a payment transaction, wherein the authorization request includes at least the received payment details and the discounted parking fee.

### FIELD

The present disclosure relates to the automatic validation of parking, specifically the tracking of payment transactions to provide automated validation for parking at the parking point of sale via a discounted transaction or reimbursement.

### BACKGROUND

In many places, particularly near shopping malls and in heavily populated areas, consumers have to pay to park. Parking fees are received by the operator of a parking lot of structure to recoup costs in the building and maintenance of the lot, cover the wages of any employees (e.g., parking attendants), pay for rent, property taxes, or other recurring expenses, and can, ideally, serve as source of profit. However, in instances where alternative parking may be available that is less expensive than a particular lot, consumers may be reluctant to pay for their parking, or may opt to shop somewhere else, so both the merchants and parking facilities owners may be motivated to attract customers.

As a result, many parking lots and structures offer discounts to consumers via parking validation. Parking validation often involves the consumer visiting a participating merchant that has an agreement with the parking provider. In some cases the merchant may require the consumer to purchase an item prior to validation of their parking, but in other cases, may only require the consumer to visit the premises of the merchant. The consumer is then afforded a discount on their parking, which might be paid for by the merchant, the landlord, or absorbed by the parking provider. The parking provider may still receive the full parking amount, while the consumer receives their discount. Merchants and/or landlords, despite paying the discounted amount, often receive a benefit in the added consumer traffic and purchases via their offering of validation.

However, while validation can be beneficial to each of the parties involved, it can often be difficult to manage and require considerable computing power and/or integration of possibly different computing systems. For instance, a parking lot will employ a parking attendant to manually check for the validation in each instance. Such a method can thus cost a parking merchant extra resources in being required to re-key or otherwise input the information necessary to effectuate the discount, extra computing power to track, analyze and bill or allocate the discount among the the various entities, additional storage for the transactions that may have to be input to multiple computer systems and networks, arrange APIs between the different systems and other expenses associated with computer resources, as well as to pay employees for manual processing, which can result in a slower processing time due to the manual checking. In some cases, a parking lot may use kiosks at which a consumer can pay for their parking. However, these kiosks are often not programmed to provide for parking discounts via validation, and when they are require additional computer programming and/or equipment be installed at each participating merchant.

For instance, in instances where kiosks do provide validation discounts, they often require the consumer present a modified parking ticket that has been modified by the validating merchant or a special validation voucher machine provided at the validating merchant. In addition to the extra computer functions and/or equipment, this process requires the consumer to actively remember to both obtain the parking ticket modification or validation voucher and to also present it when paying for parking. Such a system may thus inconvenience a consumer, which may cause a decrease in consumer use of the parking lot or structure.

Thus, there is a need for a technical solution to provide for the automated validation of parking based on consumer transaction activity at a participating merchant.

### SUMMARY

The present disclosure provides a description of systems and methods for automated parking validation and parking validation reimbursement.

A method for automated parking validation includes: storing, in a memory of a computing device, a parking fee amount; receiving, by a receiving device, payment details associated with a transaction account; identifying, by a processing device, transaction data for an eligible payment transaction, wherein the transaction data includes at least a transaction time and/or date and a merchant identifier; discounting, by the processing device, the parking fee amount by a discount amount if the transaction time and/or date is within a predetermined period of time and the merchant identifier is one of a plurality of predefined merchant identifiers; and transmitting, by a transmitting device, an authorization request for a payment transaction, wherein the authorization request includes at least the received payment details and the discounted parking fee.

Another method for automated parking validation includes: storing, in a transaction database, a plurality of transaction data entries, wherein each transaction data entry includes data related to a process payment transaction including at least a transaction time and/or date, a merchant identifier, and a transaction account number; storing, in a parking database, a plurality of parking data entries, wherein each parking data entry includes data related to a parking vendor including at least a vendor identifier and a plurality of predefined merchant identifiers; receiving, by a receiving device, an authorization request for a parking transaction, wherein the authorization request includes at least a parking fee amount, a specific vendor identifier, and a specific transaction account number; identifying, in the parking database, a specific parking data entry where the included vendor identifier corresponds to the specific vendor identifier; calculating, by a processing device, a discount amount if the transaction database includes a transaction data entry where the included merchant identifier is included in the plurality of predefined merchant identifiers included in the identified specific parking data entry, where the included transaction time and/or date is within a predetermined period of time, and where the included transaction account number corresponds to the specific transaction account number; and processing, by the processing device, the parking transaction.

A method for parking validation reimbursement includes: storing, in a transaction database, a plurality of transaction data entries, wherein each transaction data entry includes data related to a payment transaction including at least a transaction time and/or date, a merchant identifier, a transaction amount, and a transaction account number; storing, in a parking database, a parking data entry, wherein the parking data entry includes data related to a parking vendor including at least a vendor identifier and a plurality of predefined merchant identifiers; identifying, in the transaction database, a specific transaction data entry related to a parking transaction where the included merchant identifier corresponds to the vendor identifier; calculating, by a processing device, a discount amount if the transaction database includes a transaction data entry where the included merchant identifier is included in the plurality of predefined merchant identifiers included in the parking data entry, where the included transaction time and/or date is within a predetermined period of time of the transaction time and/or date included in the specific transaction data entry, and where the included transaction account number corresponds to the transaction account number included in the specific transaction data entry; and processing, by the processing device, a reimbursement transaction for the calculated discount amount from a merchant associated with the merchant identifier included in the plurality of predefined merchant identifiers to a transaction account associated with the transaction account number included in the specific transaction data entry.

A system for automated parking validation includes a memory, a receiving device, a processing device, and a transmitting device. The memory of a computing device is configured to store a parking fee amount. The receiving device is configured to store payment details associated with a transaction account. The processing device is configured to: identify transaction data for an eligible payment transaction, wherein the transaction data includes at least a transaction time and/or date and a merchant identifier; and discount the parking fee amount by a discount amount if the transaction time and/or date is within a predetermined period of time and the merchant identifier is one of a plurality of predefined merchant identifiers. The transmitting device is configured to transmit an authorization request for a payment transaction, wherein the authorization request includes at least the received payment details and the discounted parking fee.

Another system for automated parking validation includes a transaction database, a parking database, a receiving device, and a processing device. The transaction database is configured to store a plurality of transaction data entries, wherein each transaction data entry includes data related to a process payment transaction including at least a transaction time and/or date, a merchant identifier, and a transaction account number. The parking database is configured to store a plurality of parking data entries, wherein each parking data entry includes data related to a parking vendor including at least a vendor identifier and a plurality of predefined merchant identifiers. The receiving device is configured to receive an authorization request for a parking transaction, wherein the authorization request includes at least a parking fee amount, a specific vendor identifier, and a specific transaction account number. The processing device is configured to: identify, in the parking database, a specific parking data entry where the included vendor identifier corresponds to the specific vendor identifier; calculate a discount amount if the transaction database includes a transaction data entry where the included merchant identifier is included in the plurality of predefined merchant identifiers included in the identified specific parking data entry, where the included transaction time and/or date is within a predetermined period of time, and where the included transaction account number corresponds to the specific transaction account number; and process the parking transaction.

A system for parking validation reimbursement includes a transaction database, a parking database, and a processing device. The transaction database is configured to store a plurality of transaction data entries, wherein each transaction data entry includes data related to a payment transaction including at least a transaction time and/or date, a merchant identifier, a transaction amount, and a transaction account number. The parking database is configured to store a parking data entry, wherein the parking data entry includes data related to a parking vendor including at least a vendor identifier and a plurality of predefined merchant identifiers. The processing device configured to: identify, in the transaction database, a specific transaction data entry related to a parking transaction where the included merchant identifier corresponds to the vendor identifier; calculate a discount amount if the transaction database includes a transaction data entry where the included merchant identifier is included in the plurality of predefined merchant identifiers included in the parking data entry, where the included transaction time and/or date is within a predetermined period of time of the transaction time and/or date included in the specific transaction data entry, and where the included transaction account number corresponds to the transaction account number included in the specific transaction data entry; and process a reimbursement transaction for the calculated discount amount from a merchant associated with the merchant identifier included in the plurality of predefined merchant identifiers to a transaction account associated with the transaction account number included in the specific transaction data entry.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for automatic parking validation in accordance with exemplary embodiments.

FIG. 2 is a block diagram illustrating the parking computing device of FIG. 1 for the automation of parking validation in accordance with exemplary embodiments.

FIG. 3 is a block diagram illustrating the processing server of FIG. 1 for automated validation of parking and validation reimbursement in accordance with exemplary embodiments.

FIG. 4 is a flow diagram illustrating a process for automatic validation of parking using the parking computing device of FIG. 2 in accordance with exemplary embodiments.

FIG. 5 is a flow diagram illustrating a process for automatic validation of parking using the processing server of FIG. 3 in accordance with exemplary embodiments.

FIG. 6 is a flow diagram illustrating the processing of parking validation reimbursements using the processing server of FIG. 3 in accordance with exemplary embodiments.

FIGS. 7 and 8 are flow charts illustrating exemplary methods for automated parking validation in accordance with exemplary embodiments.

FIG. 9 is a flow chart illustrating an exemplary method for parking validation reimbursement in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Automatic Parking Validation and Reimbursement

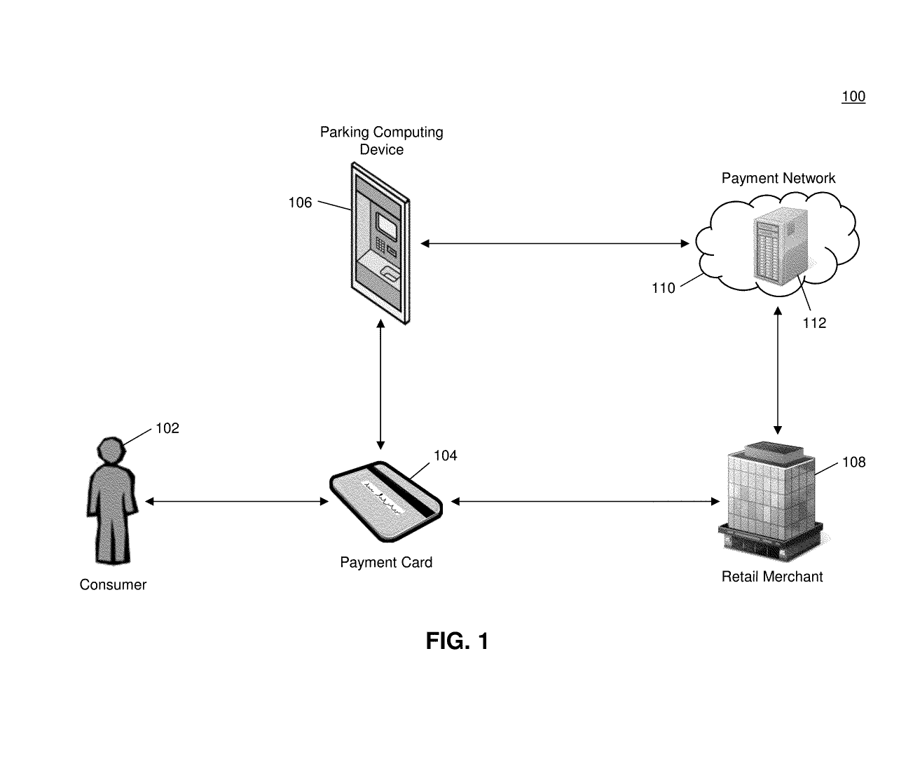

FIG. 1 illustrates a system 100 for the automatic validation and reimbursement of consumer parking fees based on transaction history.

In the system 100, a consumer 102 may park at a parking lot, parking structure, or other location at the consumer 102 may be required to pay for parking, collectively referred to herein as parking structures. Traditionally, the consumer 102 may park at the parking structure, and provide a payment card 104 to pay for the parking transaction. The payment card 104 may be inserted into, read by, or otherwise presented to a parking computing device 106. The parking computing device 106, discussed in more detail below, may be a kiosk or other suitable type of computing device associated with a parking merchant configured to receive payment details from the payment card 104 and initiate a payment transaction for parking.

As discussed in more detail below, the parking computing device 106 may be configured to provide automatic validation for the parking based on the consumer's 102 transaction history. The consumer 102 may conduct a payment transaction with a participating retail merchant 108. As part of the payment transaction, the consumer 102 may provide the payment card 104 to the retail merchant 108 as payment for the transaction. The payment transaction may then be processed by a payment network 110 using methods and systems that will be apparent to persons having skill in the relevant art.

In some embodiments, the payment card 104 may store data associated with the payment transaction involving the consumer 102 and the retail merchant 108 in the payment card 104 itself. For instance, the payment card 104 may be an EMV payment card that includes a memory, which may be used to store the transaction data. When the payment card 104 is presented to the parking computing device 106, the parking computing device 106 may receive the transaction data. The parking computing device 106 may then identify that the consumer 102 has conducted a participating validation transaction with the merchant 108 and may discount the parking fee accordingly. Identification of a suitable validation transaction may include checking merchant data for a participating merchant (e.g., the retail merchant 108), checking a transaction time and/or date (e.g., that is within a predetermined period of time of the time at which parking is being paid), checking for a minimum transaction amount, and other criteria that will be apparent to persons having skill in the relevant art. The parking transaction may then be conducted for the discounted fee by the payment network 110 using methods and systems that will be apparent to persons having skill in the relevant art.

In another embodiment, transaction data for the payment transaction involving the consumer 102 and the merchant 108 may be stored in a processing server 112 of the payment network 110, discussed in more detail below. In such an embodiment, when the payment card 104 is presented to the parking computing device 106, the parking computing device 106 may transmit a request to the processing server 112. The processing server 112 may identify if an eligible validation transaction has been conducted and notify the parking computing device 106 accordingly, or may provide any potentially eligible transaction data to the parking computing device 106 to perform the validation. The parking computing device 106 may then discount the parking fee accordingly and process the parking transaction.

In yet another embodiment, the parking computing device 106 may conduct the parking transaction using the payment card 104 normally without providing a discount. The payment transaction may be processed by the payment network 110 using the processing server 112. The processing server 112 may receive an authorization request for the parking transaction being funded by the payment card 104, and may identify an eligible payment transaction conducted by the consumer 102 and the participating retail merchant 108 using the payment card 104. The processing server 112 may then discount the parking transaction accordingly, or may process the parking transaction and then process a reimbursement for the validation amount. In some instances, the reimbursement may be paid to the consumer 102 by the retail merchant 108 involved in the validation transaction.

In yet another embodiment, the processing server 112 may be configured to provide reimbursements for earlier processed parking transactions. In such an embodiment, the processing server 112 may process reimbursements at a regular interval, such as at the end of every business day. The processing server 112 may identify parking transactions conducted during the period, and, for each parking transaction, may identify if an eligible validation transaction was conducted involving the payment card 104 used in the parking transaction and a participating retail merchant 108. If an eligible transaction is found, the processing server 112 may process a reimbursement to the transaction account associated with the payment card 104.

The methods and systems discussed herein for providing discounted parking fees and reimbursements via automatic parking validation may enable for parking computing devices 106 and processing servers 112 to improve the consumer parking experience. By automating the validation process, consumers 102 may not be required to provide any proof of conducting a validation transaction and may thus have less responsibility, and therefore less to forget, and yet still receive the validation benefit. Similarly, retail merchants 108 may be able to receive the benefits of validation without providing any additional services (e.g., modifying parking vouchers, providing validation vouchers, etc.), which could incur additional training of employee personnel and expenses. The added consumer 102 and retail merchant 108 benefit may result in the parking merchant receiving additional participating merchants 108 and consumers 102, which may thereby increase revenue.

### Parking Computing Device

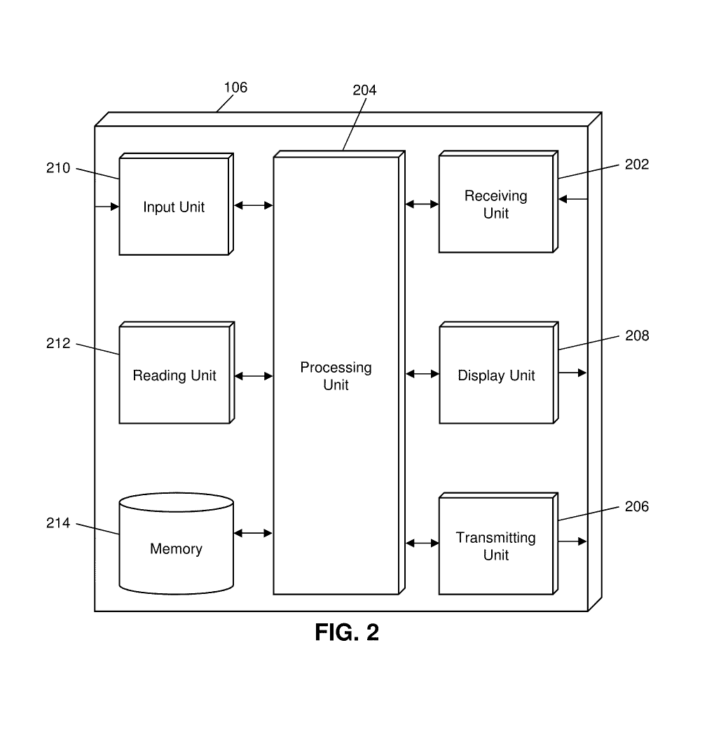

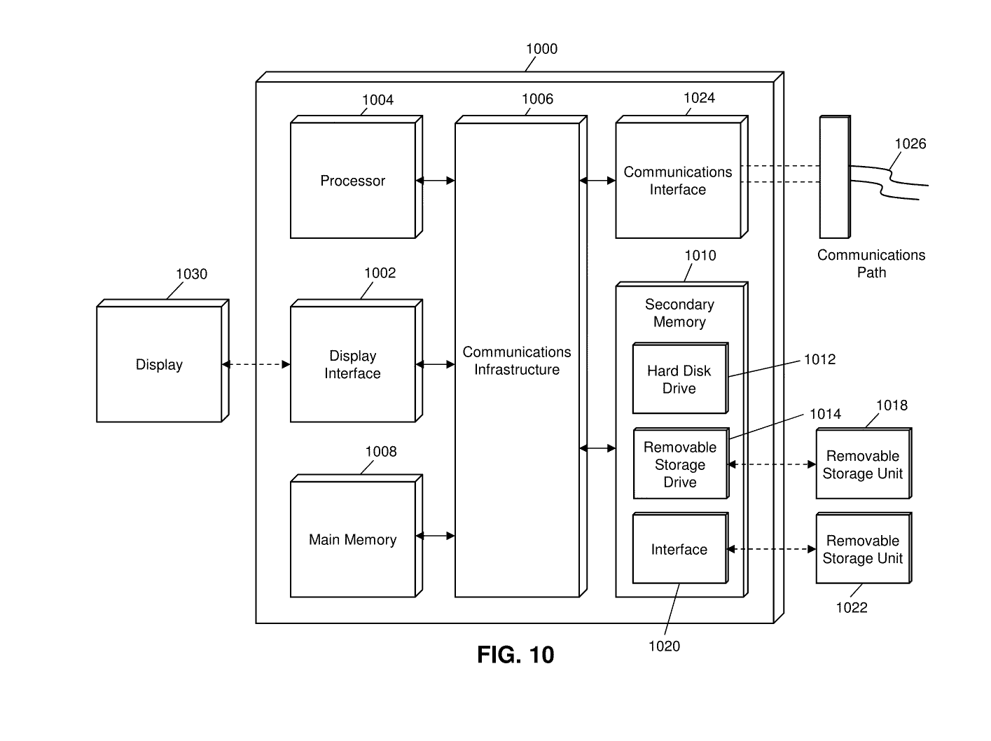

FIG. 2 illustrates an embodiment of the parking computing device 106 of the system 100. It will be apparent to persons having skill in the relevant art that the embodiment of the parking computing device 106 illustrated in FIG. 2 is provided as illustration only and may not be exhaustive to all possible configurations of the parking computing device 106 suitable for performing the functions as discussed herein. For example, the computer system 1000 illustrated in FIG. 10 and discussed in more detail below may be a suitable configuration of the parking computing device 106.

The parking computing device 106 may include a reading unit 212. The reading unit 212 may be configured to read payment details from a payment card 104. The payment details may include an account identifier associated with a transaction account related to the payment card 104 and any other data suitable for use in the conducting of a payment transaction using the payment card 104 that will be apparent to persons having skill in the relevant art. Methods for reading payment details from a payment card 104 will also be apparent to persons having skill in the relevant art, and may include reading data encoded in a magnetic stripe, receiving data from an integrated circuit embedded in the payment card 104, receiving data via near field communication, etc. In some embodiments, the reading unit 212 may also read transaction data stored in the payment card 104.

The parking computing device 106 may also include an input unit 210. The input unit 210 may be configured to communicate and/or interface with one or more input devices connected to the parking computing device 106, such as a keyboard, mouse, camera, microphone, optical scanner, etc. The input unit 210 may receive input regarding parking by the consumer 102. The input may be via a parking voucher insert by the consumer 102, by manual input of data by the consumer 102, via an application program of a mobile communication device used by the consumer 102, or other suitable method.

The parking computing device 106 may further include a processing unit 204. The processing unit 204 may be configured to perform the functions of the parking computing device 106 discussed herein as will be apparent to persons having skill in the relevant art. In some embodiments, the processing unit 204 may be configured to identify transaction data read by the reading unit 212 and determine if the transaction data corresponds to the parking data received by the input unit 210. The processing unit 204 may determine if the corresponding transaction data indicates eligibility for a validation discount for the parking. The determination may be based on a merchant identifier for the corresponding transaction being associated with a participating retail merchant 108, a transaction time and/or date for the transaction and a present time and/or date or a parking time and/or date, etc.

If the corresponding transaction is an eligible validation transaction, the processing unit 204 may be configured to discount a parking fee for the parking. The parking computing device 106 may then transmit the discounted parking fee and read payment details to the payment network 110 (e.g., via an acquiring financial institution) for processing of a payment transaction for the parking via the transmitting unit 206. The transmitting unit 206 may be configured to transmit data over one or more networks via one or more network protocols, including the transmission of transaction data and/or authorization requests to acquiring financial institutions and the payment network 110.

In some embodiments, the transmitting unit 206 may be configured to transmit read payment details, such as an account number associated with the payment card 104, to the processing server 112 of the payment network 110. In such an embodiment, the processing server 112 may identify any transaction data associated with the payment card 104 for any payment transactions and return the transaction data or an indication of validation eligibility to the parking computing device 106, to be received by a receiving unit 202. The receiving unit 202 may be configured to receive data over one or more networks via one or more network protocols. The processing unit 204 may identify the received transaction data or indication of validation eligibility and discount the parking transaction accordingly. The transmitting unit 206 may then transmit the transaction data for processing of the parking transaction.

The parking computing device 106 may also include a display unit 208. The display unit 208 may be configured to communicate and/or interface with one or more display devices used for the display of data to the consumer 102. The display devices may include cathode ray tube displays, liquid crystal displays, light-emitting diode displays, thin film transistor displays, touch screen displays, or any other suitable type of display devices. The display unit 208 may cause the display devices to display data related to the consumer parking, such as parking rates, the consumer's 102 parking information, eligible validation transactions, participating retail merchants 108, discount amounts, etc.

The parking computing device 106 may further include a memory 214. The memory 214 may be configured to store data suitable for performing the functions of the parking computing device 106 discussed herein. For example, the memory 214 may be configured to store parking rates, discount rates, algorithms for the calculation of parking amounts and discount amounts, participating retail merchant 108 data, validation data, rules or algorithms for the identification of eligible validation transactions, and additional data as will be apparent to persons having skill in the relevant art.

The components of the parking computing device 106 may also be configured to perform additional functions that will be apparent to persons having skill in the relevant art. For example, the components of the parking computing device 106 may be configured to perform the traditional functions of a parking computing device 106, such as for the reading of parking vouchers, calculation of parking amounts, and initiation of payment transactions for parking.

### Processing Server

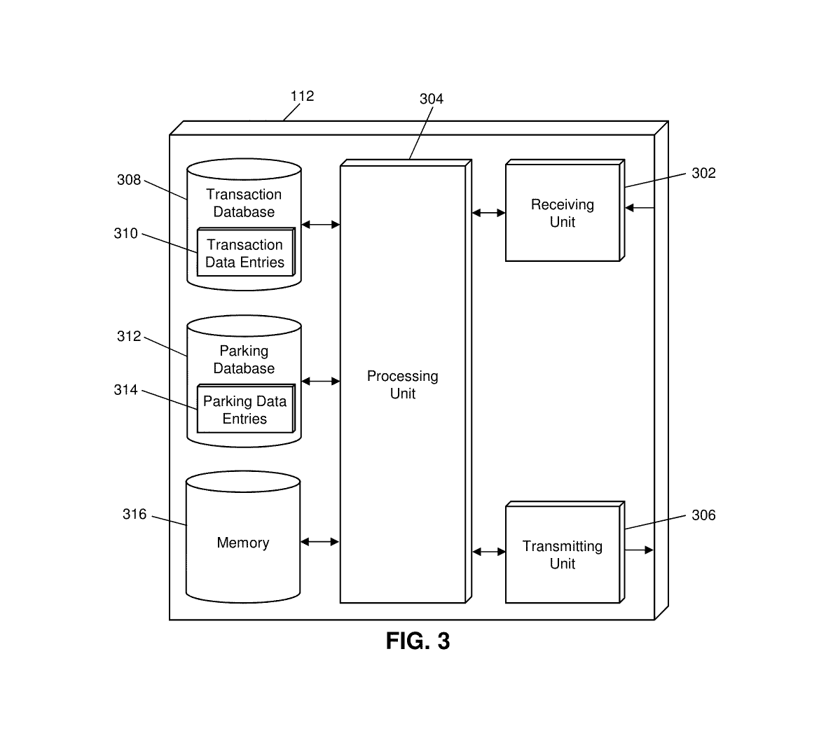

FIG. 3 illustrates an embodiment of the processing server 112 of the system 100. It will be apparent to persons having skill in the relevant art that the embodiment of the processing server 112 illustrated in FIG. 3 is provided as illustration only and may not be exhaustive to all possible configurations of the processing server 112 suitable for performing the functions as discussed herein. For example, the computer system 1000 illustrated in FIG. 10 and discussed in more detail below may be a suitable configuration of the processing server 112.

The processing server 112 may include a receiving unit 302. The receiving unit 302 may be configured to receive data over one or more networks via one or more network protocols. The receiving unit 302 may receive transaction data for payment transactions processed by the payment network 110. The receiving unit 302 may also receive requests for validation transaction data, such as from the parking computing device 106. Requests for validation transaction data may include account identifiers or other identification information associated with a payment card 104 used in a parking transaction. The receiving unit 302 may also be configured to receive authorization requests for payment transactions, which may include transaction amounts, payment details, and other data that will be apparent to persons having skill in the relevant art.

The processing server 112 may also include a transaction database 308. The transaction database 310 may be configured to store a plurality of transaction data entries 310. Each transaction data entry 310 may include data related to a processed payment transaction, such as received by the receiving unit 302. The transaction data may include an account identifier associated with a payment card 104 used to fund the related payment transaction, a transaction time and/or date, transaction amount, geographic location, merchant data (e.g., associated with a retail merchant 108 or parking merchant involved in the payment transaction), point of sale data (e.g., associated with the parking computing device 106 in parking transactions), and other data that will be apparent to persons having skill in the relevant art.

The processing server 112 may also include a parking database 312. The parking database 312 may be configured to store a plurality of parking data entries 314. Each parking data entry 314 may include data related to a parking vendor or merchant, such as associated with the parking computing device 106, and may include at least a vendor identifier and a plurality of predefined merchant identifiers. The vendor identifier may be a unique value associated with the parking merchant. The plurality of predefined merchant identifiers may include merchant identifiers that are unique values associated with participating retail merchants 108 associated with the parking vendor that provide validation. The unique values may include merchant identification numbers or other suitable values as will be apparent to persons having skill in the relevant art.

The processing server 112 may also include a processing unit 304. The processing unit 304 may be configured to perform the functions of the processing server 112 discussed herein as will be apparent to persons having skill in the relevant art. The processing unit 304 may be configured to identify transaction data entries 310 that are related to a payment card 104 based on payment details received by the receiving unit 302, such as an account identifier, which may be included in the transaction data in the identified transaction data entries 310. The processing unit 304 may also be configured to identify eligible validation transaction data entries 310, which may be identified based on parking data received by the receiving unit 302 and a transaction time and/or date, included merchant identifier, etc. For instance, a transaction data entry 310 eligible for validation may include a merchant identifier that is included in the plurality of merchant identifiers in a parking data entry 314 that includes a vendor identifier included in the received parking data.

In some embodiments, the processing unit 304 may also be configured to calculate discounted transaction amounts for parking transactions based on validation. For instance, if the receiving unit 302 receives an authorization request for a parking transaction, the processing unit 304 may determine if an eligible validation transaction was conducted using the same payment card 104 used in the parking transaction (e.g., by identification of a corresponding transaction data entry 310 in the transaction database 308) and may calculate a discounted transaction amount accordingly. The processing unit 304 may process the discounted parking transaction using methods and systems that will be apparent to persons having skill in the relevant art. In such embodiments, the processing unit 304 may also process a transaction for the discount amount to be paid from the retail merchant 108 involved in the validation transaction to the parking vendor involved in the parking transaction.

The processing unit 304 may also be configured to process reimbursements. A reimbursement may be a payment transaction processed subsequent to a parking transaction for the validation amount to be paid from the retail merchant 108 involved in the validation transaction to a transaction account associated with the payment card 104 used in the parking and validation transactions. In some instances, the processing unit 304 may be configured to process a reimbursement subsequent to the processing of the parking transaction. In other instances, the processing unit 304 may be configured to process reimbursements at predetermined periods of time. For example, the processing unit 304 may be configured to, at a predetermined interval (e.g., daily), identify all transaction data entries 310 related to parking transactions in the transaction database (e.g., where the included merchant identifier is associated with a parking vendor), identify any eligible validation transactions for those transaction data entries 310, and process reimbursements accordingly.

The processing server 112 may also include a transmitting unit 306. The transmitting unit 306 may be configured to transmit data over one or more networks via one or more network protocols. The transmitting unit 306 may transmit transaction data or an indication of an eligible validation transaction to the parking computing device 106, such as in response to a request received by the receiving unit 302. The transmitting unit 306 may also be configured to transmit data associated with the processing of payment transactions, such as transmitting transaction data to an issuer for approval of a payment transaction, transmitting authorization responses in response to authorization requests, etc.

The processing server 112 may further include a memory 316. The memory 316 may be configured to store data for the processing server 112 suitable for performing the functions discussed herein. For example, the memory 316 may be configured to store rules regarding validation eligibility, rules or algorithms for the calculation of validation or reimbursement amounts, and other data that will be apparent to persons having skill in the relevant art.

The components of the processing server 112 may also be configured to perform additional functions that will be apparent to persons having skill in the relevant art. For example, the components of the processing server 112 may be configured to perform the traditional functions of a payment network 110, such as for the processing of payment transactions, processing of reimbursements, etc.

### Automatic Validation at the Parking Computing Device

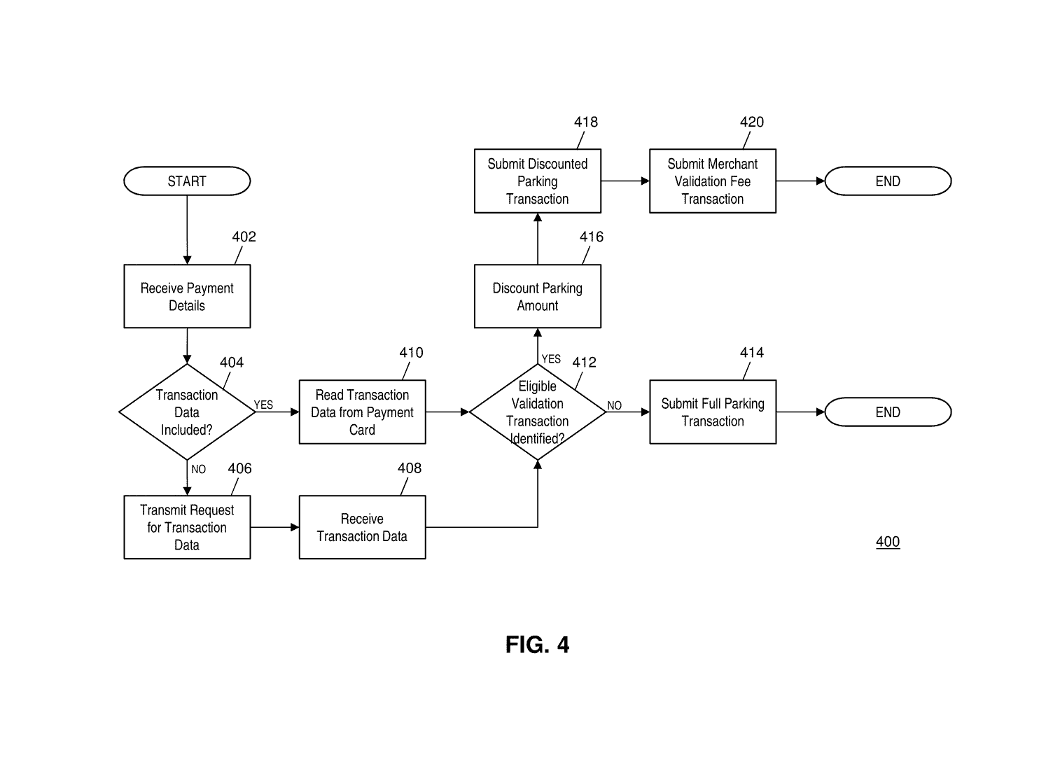

FIG. 4 illustrates a process 400 for automatic parking validation to be performed by the parking computing device 106.

In step 402, the receiving unit 202 and/or reading unit 212 of the parking computing device 106 may receive payment details from a payment card 104 for a parking transaction. The payment details may include at least an account identifier or other suitable identification information associated with a transaction account associated with the payment card 104. In step 404, the processing unit 204 of the parking computing device 106 may determine if transaction data is included in the received payment details.

If no transaction data is included, then, in step 406, the transmitting unit 206 of the parking computing device 106 may transmit a request for transaction data to the payment network 110. The request for transaction data may include at least the account identifier or other identification information received in the payment details. In step 408, the receiving unit 202 may receive transaction data for payment transactions involving the payment card 104 identified by the payment network 110. In some embodiments, the receiving unit 202 may only receive an indication if an eligible validation transaction was conducted involving the payment card 104.

If transaction data was included in the received payment details, then, in step 410, the reading unit 212 may read the transaction data from the payment card 104, such as from a memory included in an integrated circuit in the payment card 104. The read transaction data may include at least a merchant identifier and a transaction time and/or date. Once transaction data has been identified or received by the parking computing device 106, then, in step 412, the processing unit 204 may determine if an eligible validation transaction was conducted involving the payment card 104. The determination may be based on if the merchant identifier for a conducted transaction corresponds to a participating retail merchant 108 and if the transaction time and/or date is within a predetermined period of time, such as based on the present time and/or the time at which the consumer 102 parked.

If no eligible transaction is identified, then, in step 414, the processing unit 204 may initiate processing of the parking transaction for the full parking amount using methods and systems that will be apparent to persons having skill in the relevant art. If an eligible transaction is identified, then, in step 416, the processing unit 204 may calculate a discounted parking amount as a result of the validation. In some embodiments, the discounted amount may be based on the retail merchant 108 involved in the validation transaction, the transaction amount of the validation transaction, and other criteria that will be apparent to persons having skill in the relevant art.

In step 418, the transmitting unit 206 may transmit an authorization request for the discounted parking transaction to the payment network 110 for processing. The authorization request may include the read payment details and the discounted parking amount. In step 420, the transmitting unit 206 may transmit an authorization request for a validation fee transaction for a validation fee (e.g., which may correspond to the discount amount) to be paid from the retail merchant 108 involved in the validation transaction to the parking vendor.

### Automatic Validation at the Processing Server

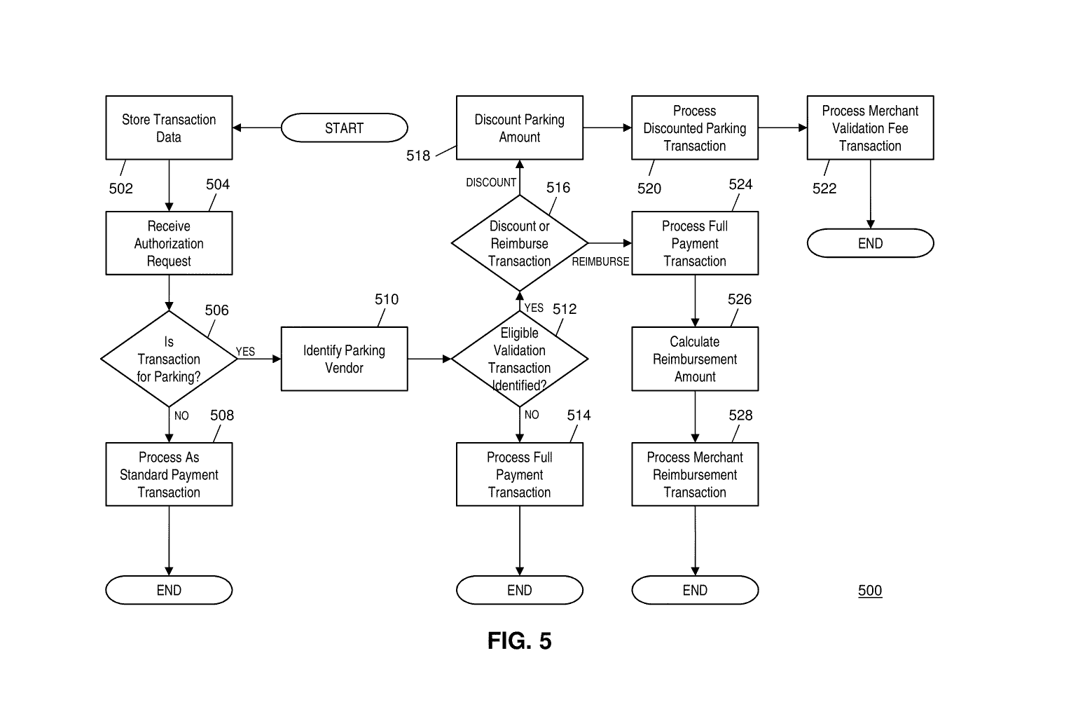

FIG. 5 illustrates a process 500 for the automatic validation of parking to be performed at the processing server 112.

In step 502, transaction data may be stored in the transaction database 308 of the processing server 112 in a plurality of transaction data entries 310. Each transaction data entry 310 may include at least a merchant identifier associated with a merchant involved in the payment transaction and an account identifier associated with a payment card 104 used to fund the payment transaction. In step 504, the receiving unit 302 of the processing server 112 may receive an authorization request for a payment transaction. The authorization request may include at least a merchant identifier associated with a merchant involved in the transaction, an account identifier associated with a payment card 104 used to fund the transaction, and a transaction amount.

In step 506, the processing unit 304 of the processing server 112 may determine if the payment transaction is a transaction to pay for parking. The determination may be based on the merchant identifier (e.g., if it is associated with a parking vendor), a point of sale identifier (e.g., associated with a parking computing device 106), a specific data value included in the authorization request, or other suitable method. If the transaction is not a transaction for parking, then, in step 508, the processing unit 304 may process the payment transaction using standard processing procedures.

If the payment transaction is a parking transaction, then, in step 510, the processing unit 304 may identify a parking data entry 314 stored in the parking database 312 of the processing server 112 that is associated with the parking vendor. The identified parking data entry 314 may include a vendor identifier associated with the vendor, such as corresponding to the merchant identifier included in the received authorization request. In step 512, the processing unit 304 may determine if an eligible validation transaction has been conducted involving the payment card 104 used in the parking transaction. The determination may be based on an identification of a transaction data entry 310 in the transaction database 308 that includes a merchant identifier included in the plurality of merchant identifiers of the identified parking data entry 314 that also fulfills any additional validation criteria, such as a transaction time and/or date that is within a predetermined period of time of the parking transaction.

If no eligible validation transaction is identified, then, in step 514, the processing unit 304 may process the parking transaction for the full amount using standard processing procedures. If a validation transaction is identified, then, in step 516, the processing unit 304 may determine if the parking transaction is to be discounted or if the retail merchant 108 involved in the validation transaction is to reimburse the consumer 102 associated with the payment card 104. If the parking transaction is to be discounted, then, in step 518, the processing unit 304 may calculate the discounted parking amount based on the validation transaction. In step 520, the processing unit 304 may process the parking transaction for the discounted amount using standard processing procedures. In step 522, the processing unit 304 may process a second transaction for a validation fee to be paid by the retail merchant 108 to the parking vendor.

If the parking transaction is to be reimbursed, then, in step 524, the processing unit 304 may process the parking transaction for the full amount using standard processing procedures. In step 526, the processing unit 304 may calculate a reimbursement amount to be provided to the consumer 102 based on the validation transaction. In step 528, a second payment transaction for payment of the reimbursement amount to the consumer 102 from the retail merchant 108 may be processed using standard processing procedures.

### Automatic Reimbursement Based on Parking Validation

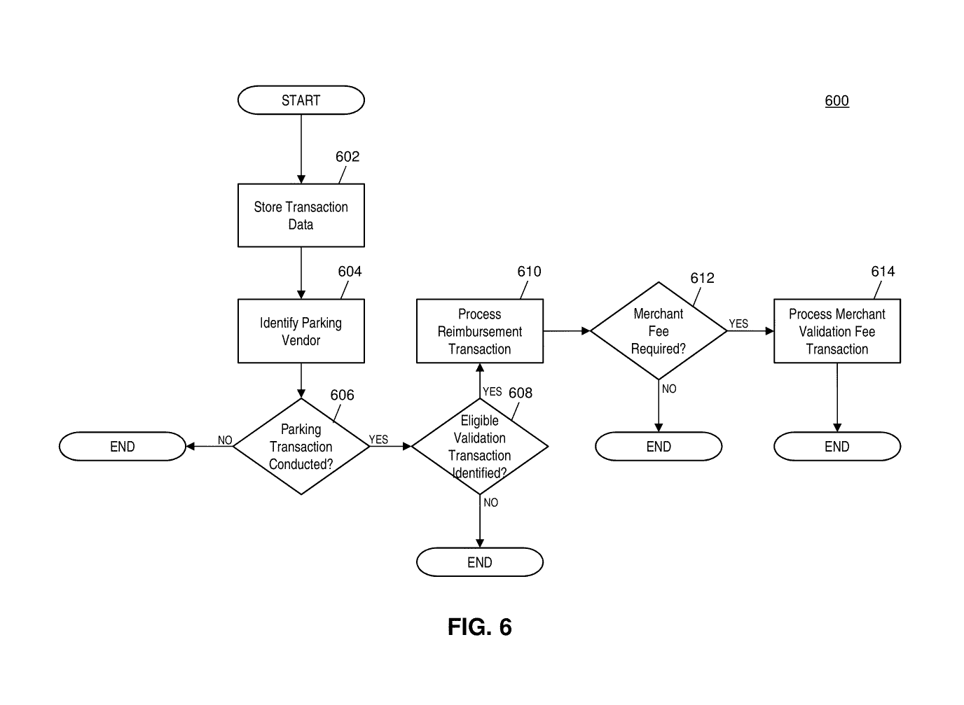

FIG. 6 illustrates the automatic reimbursement of parking fees based on validation transactions using the processing server 112.

In step 602, transaction data may be stored in the transaction database 308 of the processing server 112 in a plurality of transaction data entries 310. Each transaction data entry 310 may include at least a merchant identifier associated with a merchant involved in the payment transaction and an account identifier associated with a payment card 104 used to fund the payment transaction. In step 604, the processing unit 304 of the processing server 112 may identify a parking vendor for which reimbursements will be identified. Identification of the parking vendor may include identification of a parking data entry 314 in the parking database 312 of the processing server 112 that includes a vendor identifier associated with the parking vendor.

In step 606, the processing unit 304 may determine if any parking transactions were conducted since the last check for reimbursements involving the parking vendor. The determination may be based on the identification of any transaction data entries 310 that include merchant identifiers corresponding to the vendor identifier associated with the parking vendor. If no parking transactions were conducted involving the parking vendor, then the process 600 may be completed.

If parking transactions are identified, then, in step 608, the processing unit 304 may determine if any validation transactions were conducted for each of the parking transactions. The determination may be based on the identification of any transaction data entries 310 that include the same payment card 104 used in the parking transaction and that include a merchant identifier included in the plurality of merchant identifiers in the parking data entry 314 that also satisfies one or more validation requirements, such as a transaction time and/or date that is within a predetermined period of time, such as having a transaction time that is within a six hour period prior to the parking transaction.

If no eligible validation transaction is identified, then no reimbursement may be processed for the parking transaction. If an eligible validation transaction is identified, then, in step 610, the processing unit 304 may process a payment transaction for the reimbursement of a validation amount to the transaction account associated with the payment card 104 used in the parking transaction. In step 612, the processing unit 304 may determine if the retail merchant 108 involved in the validation transaction is to pay a fee to the parking vendor as a result of the reimbursement. In some embodiments, the determination may be based on data included in the parking data entry 314, which may be based on, for instance, an agreement between the parking vendor and the retail merchant 108.

If no fee is required to be paid by the retail merchant 108, then the process 600 may be completed. If a fee is required to be paid, then, in step 614, the processing unit 304 may process a payment transaction for payment of a merchant validation fee from the retail merchant 108 to the parking vendor.

### First Exemplary Method for Automated Parking Validation

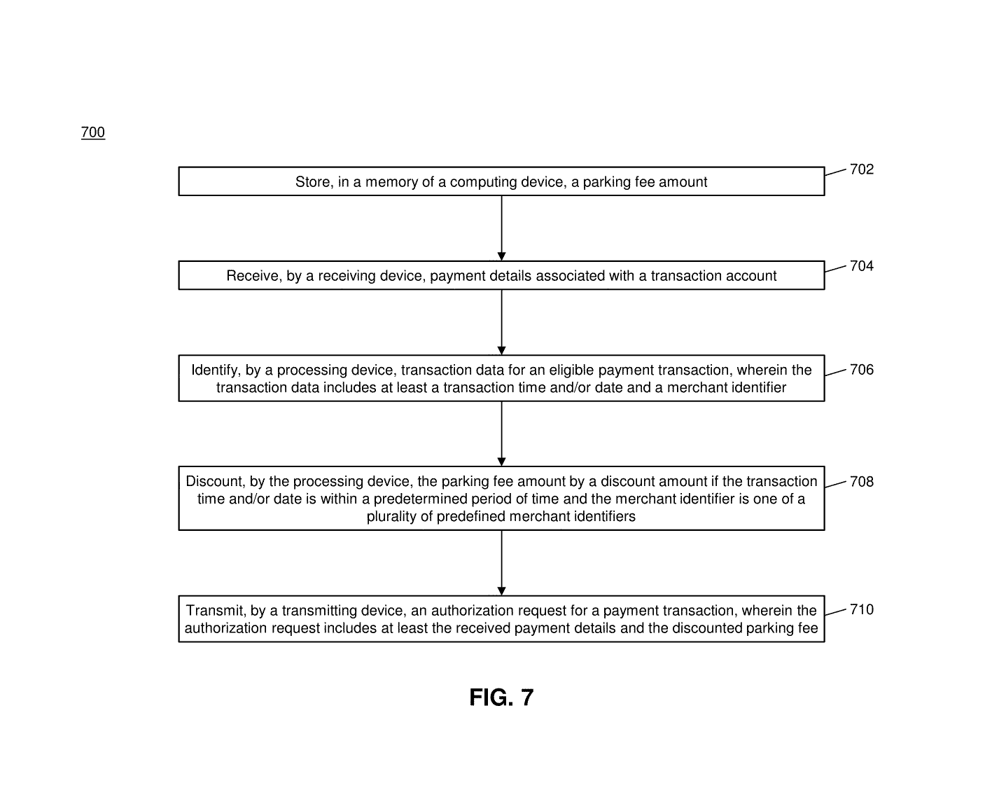

FIG. 7 illustrates a method 700 for the automatic validation of parking in a parking transaction based on transaction history.

In step 702, a parking fee amount may be stored in a memory (e.g., the memory 214) of a computing device (e.g., the parking computing device 106). In step 704, payment details associated with a transaction account may be received by a receiving device (e.g., the receiving unit 202).

In step 706, transaction data for an eligible payment transaction may be identified by a processing device (e.g., the processing unit 204), wherein the transaction data includes at least a transaction time and/or date and a merchant identifier. In one embodiment, identifying the transaction data for an eligible payment transaction may include receiving, by an input device (e.g., the input unit 210) an inserted payment card (e.g., the payment card 104), and reading, by a reading device (e.g., the reading unit 212), the payment details encoded in the inserted payment card 104 and the transaction data stored in a memory of the inserted payment card. In another embodiment, identifying the transaction data for an eligible payment transaction may include transmitting, by a transmitting device (e.g., the transmitting unit 206), the received payment details, and receiving, by the receiving device 202, the transaction data.

In step 708, the parking fee amount may be discounted by the processing device 204 by a discount amount if the transaction time and/or date is within a predetermined period of time and the merchant identifier is one of a plurality of predefined merchant identifiers. In one embodiment, the predetermined period of time may be within a predetermined time of a present time identified by the processing device 204. In some embodiments, the plurality of merchant identifiers may be stored in the memory 214 of the computing device 106.

In step 710, an authorization request for a payment transaction may be transmitted by the transmitting device 206, wherein the authorization request includes at least the received payment details and the discounted parking fee. In some embodiments, the method 700 may further include transmitting, by the transmitting device 206, an authorization request for a second payment transaction, wherein the authorization request includes at least the merchant identifier and the discount amount.

### Second Exemplary Method for Automated Parking Validation

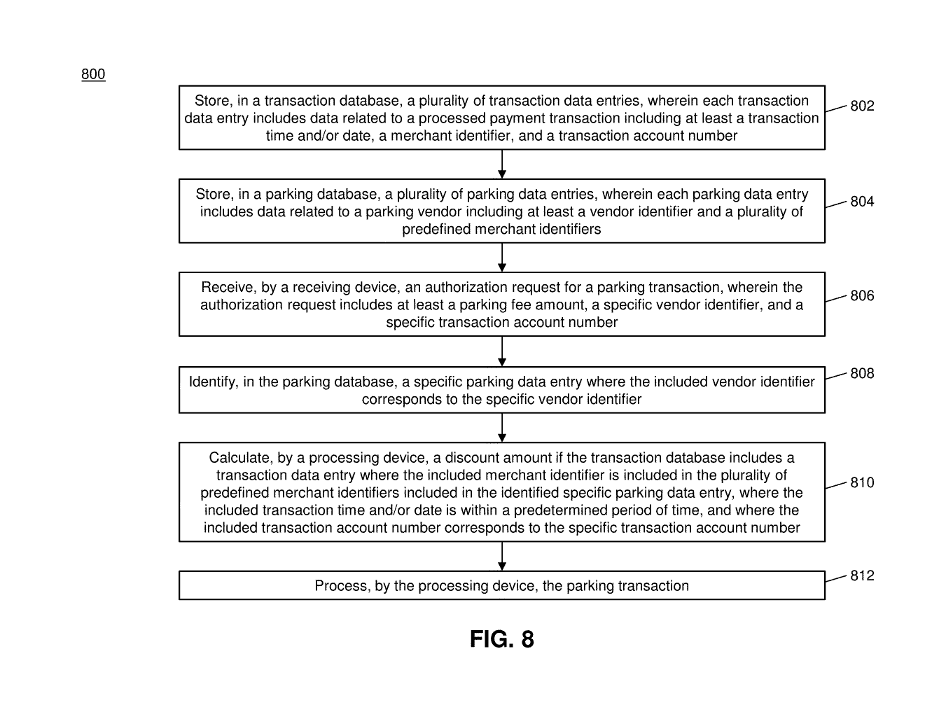

FIG. 8 illustrates a method 800 for the automatic validation of parking in a parking transaction based on transaction history.

In step 802, a plurality of transaction data entries (e.g., transaction data entries 310) may be stored in a transaction database (e.g., the transaction database 308), wherein each transaction data entry 310 includes data related to a processed payment transaction including at least a transaction time and/or date, a merchant identifier, and a transaction account number. In step 804, a plurality of parking data entries (e.g., parking data entries 314) may be stored in a parking database (e.g., the parking database 312), wherein each parking data entry 314 includes data related to a parking vendor including at least a vendor identifier and a plurality of merchant identifiers.

In step 806, an authorization request for a parking transaction may be received by a receiving device (e.g., the receiving unit 302), wherein the authorization request includes at least a parking fee amount, a specific vendor identifier, and a specific transaction account number. In step 808, a specific parking data entry 314 may be identified in the parking database 312 where the included vendor identifier corresponds to the specific vendor identifier.

In step 810, a discount amount may be calculated by a processing device (e.g., the processing unit 304) if the transaction database 308 includes a transaction data entry 310 where the included merchant identifier is included in the plurality of predefined merchant identifiers included in the identified specific parking data entry 314, where the included transaction time and/or date is within a predetermined period of time, and where the included transaction account number corresponds to the specific transaction account number. In one embodiment, the predetermined period of time may be within a predetermined time of a present time identified by the processing device 304. In some embodiments, the authorization request may include a parking transaction time and/or date, and the predetermined period of time may be within a predetermined time of the parking transaction time and/or date.

In step 812, the parking transaction may be processed by the processing device 304. In one embodiment, the method 800 may further include discounting the parking fee amount by the calculated amount, where the parking transaction is processed for the discounted parking fee amount. In another embodiment, the method 800 may further include processing, by the processing device 304, a second transaction for the calculated discount amount from a merchant (e.g., the retail merchant 108) associated with the merchant identifier to a transaction account associated with the specific transaction account number.

### Exemplary Method for Parking Validation Reimbursement

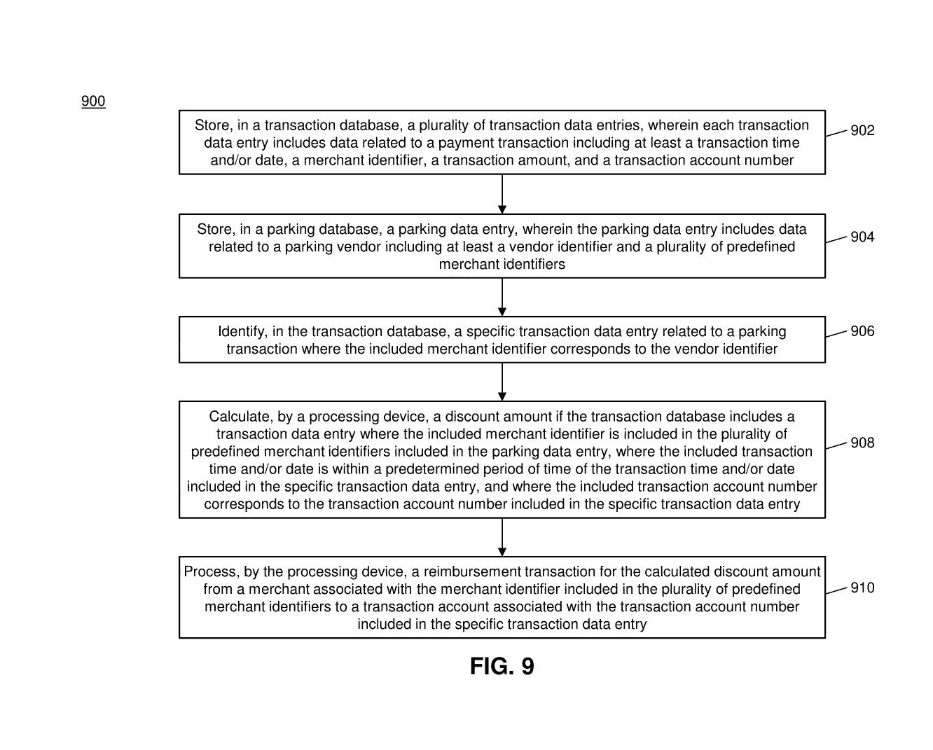

FIG. 9 illustrates a method 900 for the automatic reimbursement of parking fees based on automatic identified of a validation transaction using stored transaction history.

In step 902, a plurality of transaction data entries (e.g., transaction data entries 310) may be stored in a transaction database (e.g., the transaction database 308), wherein each transaction data entry 310 includes data related to a payment transaction including at least a transaction time and/or date, a merchant identifier, a transaction amount, and a transaction account number. In step 904, a parking data entry (e.g., parking data entry 314) may be stored in a parking database (e.g., the parking database 312), wherein the parking data entry 314 includes data related to a parking vendor including at least a vendor identifier and a plurality of predefined merchant identifiers.

In step 906, a specific transaction data entry 310 related to a parking transaction may be identified in the transaction database 308 where the included merchant identifier corresponds to the vendor identifier. In step 908, a discount amount may be calculated by a processing device (e.g., the processing unit 304) if the transaction database 308 includes a transaction data entry 310 where the included merchant identifier is included in the plurality of predefined merchant identifiers included in the parking data entry 314, where the included transaction time and/or date is within a predetermined period of time of the transaction time and/or date included in the specific transaction data entry, and where the included transaction account number corresponds to the transaction account number included in the specific transaction data entry 310.

In step 910, a reimbursement transaction may be processed, by the processing device 304, for the calculated discount amount from a merchant (e.g., the retail merchant 108) associated with the merchant identifier included in the plurality of predefined merchant identifiers to a transaction account associated with the transaction account number included in the specific transaction data entry 310. In one embodiment, processing the reimbursement transaction may include processing a first transaction for the calculated discount amount from the merchant 108 to a merchant associated with the vendor identifier and processing a second transaction for the calculated discount amount from the merchant associated with the vendor identifier to the transaction account associated with the transaction account number included in the specific transaction data entry 310.

### Computer System Architecture

FIG. 10 illustrates a computer system 1000 in which embodiments of the present disclosure, or portions thereof, may be implemented as computer-readable code. For example, the parking computing device 106 and processing server 112 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 4-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for automated parking validation and automated validation reimbursement. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for automated parking validation, comprising:
storing, in a memory of a computing device, a parking fee amount;
receiving, by a receiving device, payment details associated with a transaction account;
identifying, by a processing device, transaction data for an eligible payment transaction, wherein the transaction data includes at least a transaction time and/or date and a merchant identifier;
discounting, by the processing device, the parking fee amount by a discount amount if the transaction time and/or date is within a predetermined period of time and the merchant identifier is one of a plurality of predefined merchant identifiers; and
transmitting, by a transmitting device, an authorization request for a payment transaction, wherein the authorization request includes at least the received payment details and the discounted parking fee.

2. The method of claim 1, wherein identifying the transaction data for an eligible transaction comprises:
receiving, by an input device, an inserted payment card; and
reading, by a reading device, the payment details encoded in the inserted payment card and the transaction data stored in a memory of the inserted payment card.

3. The method of claim 1, wherein identifying the transaction data for an eligible transaction comprises:
transmitting, by the transmitting device, the received payment details; and
receiving, by the receiving device, the transaction data.

4. The method of claim 1, wherein the predetermined period of time is within a predetermined time of a present time identified by the processing device.

5. The method of claim 1, further comprising:
storing, in the memory of the computing device, the plurality of predefined merchant identifiers.

6. The method of claim 1, further comprising:
transmitting, by the transmitting device, an authorization request for a second payment transaction, wherein the authorization request includes at least the merchant identifier and the discount amount.

7. A method for automated parking validation, comprising:
storing, in a transaction database, a plurality of transaction data entries, wherein each transaction data entry includes data related to a process payment transaction including at least a transaction time and/or date, a merchant identifier, and a transaction account number;
storing, in a parking database, a plurality of parking data entries, wherein each parking data entry includes data related to a parking vendor including at least a vendor identifier and a plurality of predefined merchant identifiers;
receiving, by a receiving device, an authorization request for a parking transaction, wherein the authorization request includes at least a parking fee amount, a specific vendor identifier, and a specific transaction account number;
identifying, in the parking database, a specific parking data entry where the included vendor identifier corresponds to the specific vendor identifier;
calculating, by a processing device, a discount amount if the transaction database includes a transaction data entry where the included merchant identifier is included in the plurality of predefined merchant identifiers included in the identified specific parking data entry, where the included transaction time and/or date is within a predetermined period of time, and where the included transaction account number corresponds to the specific transaction account number; and
processing, by the processing device, the parking transaction.

8. The method of claim 7, further comprising:
discounting, by the processing device, the parking fee amount by the calculated discount amount, wherein
the parking transaction is processed for the discounted parking fee amount.

9. The method of claim 7, further comprising:
processing, by the processing device, a second transaction for the calculated discount amount from a merchant associated with the merchant identifier to a transaction account associated with the specific transaction account number.

10. The method of claim 7, wherein the predetermined period of time is within a predetermined time of a present time identified by the processing device.

11. The method of claim 7, wherein
the authorization request further includes a parking transaction time and/or date, and
the predetermined period of time is within a predetermined time of the parking transaction time and/or date.

12. A method for parking validation reimbursement, comprising:
storing, in a transaction database, a plurality of transaction data entries, wherein each transaction data entry includes data related to a payment transaction including at least a transaction time and/or date, a merchant identifier, a transaction amount, and a transaction account number;
storing, in a parking database, a parking data entry, wherein the parking data entry includes data related to a parking vendor including at least a vendor identifier and a plurality of predefined merchant identifiers;
identifying, in the transaction database, a specific transaction data entry related to a parking transaction where the included merchant identifier corresponds to the vendor identifier;
calculating, by a processing device, a discount amount if the transaction database includes a transaction data entry where the included merchant identifier is included in the plurality of predefined merchant identifiers included in the parking data entry, where the included transaction time and/or date is within a predetermined period of time of the transaction time and/or date included in the specific transaction data entry, and where the included transaction account number corresponds to the transaction account number included in the specific transaction data entry; and
processing, by the processing device, a reimbursement transaction for the calculated discount amount from a merchant associated with the merchant identifier included in the plurality of predefined merchant identifiers to a transaction account associated with the transaction account number included in the specific transaction data entry.

13. The method of claim 12, wherein processing the reimbursement transaction includes
processing a first transaction for the calculated discount amount from the merchant associated with the merchant identifier included in the plurality of predefined merchant identifiers to a merchant associated with the vendor identifier, and
processing a second transaction for the calculated discount amount from the merchant associated with the vendor identifier to the transaction account associated with the transaction account number included in the specific transaction data entry.

14. A system for automated parking validation, comprising:
a memory of a computing device configured to store a parking fee amount;
a receiving device configured to store payment details associated with a transaction account;
a processing device, configured to
identify transaction data for an eligible payment transaction, wherein the transaction data includes at least a transaction time and/or date and a merchant identifier, and
discount the parking fee amount by a discount amount if the transaction time and/or date is within a predetermined period of time and the merchant identifier is one of a plurality of predefined merchant identifiers; and
a transmitting device configured to transmit an authorization request for a payment transaction, wherein the authorization request includes at least the received payment details and the discounted parking fee.

15. The system of claim 14, wherein identifying the transaction data for an eligible transaction comprises:
receiving, by an input device, an inserted payment card; and
reading, by a reading device, the payment details encoded in the inserted payment card and the transaction data stored in a memory of the inserted payment card.

16. The system of claim 14, wherein identifying the transaction data for an eligible transaction comprises:
transmitting, by the transmitting device, the received payment details; and
receiving, by the receiving device, the transaction data.

17. The system of claim 14, wherein the predetermined period of time is within a predetermined time of a present time identified by the processing device.

18. The system of claim 14, wherein the memory of the computing device is further configured to store the plurality of predefined merchant identifiers.

19. The system of claim 14, wherein the transmitting device is further configured to transmit an authorization request for a second payment transaction, wherein the authorization request includes at least the merchant identifier and the discount amount.

20. A system for automated parking validation, comprising:
a transaction database configured to store a plurality of transaction data entries, wherein each transaction data entry includes data related to a process payment transaction including at least a transaction time and/or date, a merchant identifier, and a transaction account number;
a parking database configured to store a plurality of parking data entries, wherein each parking data entry includes data related to a parking vendor including at least a vendor identifier and a plurality of predefined merchant identifiers;
a receiving device configured to receive an authorization request for a parking transaction, wherein the authorization request includes at least a parking fee amount, a specific vendor identifier, and a specific transaction account number; and
a processing device configured to
identify, in the parking database, a specific parking data entry where the included vendor identifier corresponds to the specific vendor identifier,
calculate a discount amount if the transaction database includes a transaction data entry where the included merchant identifier is included in the plurality of predefined merchant identifiers included in the identified specific parking data entry, where the included transaction time and/or date is within a predetermined period of time, and where the included transaction account number corresponds to the specific transaction account number, and
process the parking transaction.

21. The system of claim 20, wherein
the processing device is further configured to discount the parking fee amount by the calculated discount amount, and
the parking transaction is processed for the discounted parking fee amount.

22. The system of claim 20, wherein the processing device is further configured to process a second transaction for the calculated discount amount from a merchant associated with the merchant identifier to a transaction account associated with the specific transaction account number.

23. The system of claim 20, wherein the predetermined period of time is within a predetermined time of a present time identified by the processing device.

24. The system of claim 20, wherein
the authorization request further includes a parking transaction time and/or date, and
the predetermined period of time is within a predetermined time of the parking transaction time and/or date.

25. A system for parking validation reimbursement, comprising:
a transaction database configured to store a plurality of transaction data entries, wherein each transaction data entry includes data related to a payment transaction including at least a transaction time and/or date, a merchant identifier, a transaction amount, and a transaction account number;
a parking database configured to store a parking data entry, wherein the parking data entry includes data related to a parking vendor including at least a vendor identifier and a plurality of predefined merchant identifiers; and
a processing device configured to
identify, in the transaction database, a specific transaction data entry related to a parking transaction where the included merchant identifier corresponds to the vendor identifier,
calculate a discount amount if the transaction database includes a transaction data entry where the included merchant identifier is included in the plurality of predefined merchant identifiers included in the parking data entry, where the included transaction time and/or date is within a predetermined period of time of the transaction time and/or date included in the specific transaction data entry, and where the included transaction account number corresponds to the transaction account number included in the specific transaction data entry, and
process a reimbursement transaction for the calculated discount amount from a merchant associated with the merchant identifier included in the plurality of predefined merchant identifiers to a transaction account associated with the transaction account number included in the specific transaction data entry.

26. The system of claim 25, wherein processing the reimbursement transaction includes
processing a first transaction for the calculated discount amount from the merchant associated with the merchant identifier included in the plurality of predefined merchant identifiers to a merchant associated with the vendor identifier, and
processing a second transaction for the calculated discount amount from the merchant associated with the vendor identifier to the transaction account associated with the transaction account number included in the specific transaction data entry.
